(19) United States
(12) Patent Application Publication
(10) Pub. No.: US 2009/0289582 A1
(43) Pub. Date: Nov. 26, 2009

(54) LAMP ASSEMBLIES, LAMP SYSTEMS, AND METHODS OF OPERATING LAMP SYSTEMS

(75) Inventors: David Armitage, Sunningdale (GB); Jonathan Drayton, Warfield (GB); Quinton Stowell, Maidenhead (GB)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/126,805

(22) Filed: May 23, 2008

(51) Int. Cl. H05B 37/02; G04B 47/00

(52) U.S. Cl. 315/363; 368/10

(57) ABSTRACT

Lamp systems, lamp assemblies, and methods of operating a lamp system are provided. The lamp system includes a lamp head and a lamp assembly having at least one end fixture for securing the lamp assembly in the lamp head. A data carrier is mounted to lamp assembly. The data carrier is configured to store an identifier, or operational data, or data representing the number of hours of operation, or data representing the lamp type associated with the lamp assembly, or any combination thereof. A data reader is configured to read information stored on the data carrier. A controller is operable to process the information read from the data carrier. The data carrier may alternatively store data representing the number of hours of operation and the lamp system may further include a data writer for updating the stored data to reflect operation of the lamp assembly.

### TECHNICAL FIELD

This invention relates generally to lamp assemblies, lamp systems, and methods of operating such lamp systems for use in curing or drying adhesives, sealants, inks, coatings, and other types of materials.

### TECHNICAL BACKGROUND

Lamp systems are commonly used for curing or drying adhesives, sealants, inks, coatings, and other similar materials. A conventional ultraviolet lamp system typically includes an lamp assembly and a lamp head to which the lamp assembly is mounted. The lamp assembly includes an bulb or lamp defining an envelope that confines a spectral fill (mercury, gallium, iron, etc.) and a pair of holders secured to the opposite ends of the lamp. In certain varieties of lamp systems, each of the holders is connected to a power source via the lamp head for energizing the spectrial fill confined inside the lamp. When energized, the gases of the spectral fill emit radiation in the ultraviolet band of the electromagnetic spectrum.

As can be appreciated, each lamp assembly is a consumable part that has a finite life beyond which the lamp either fails or the output of ultraviolet light declines to an insufficient level. When either event occurs, the lamp assembly must be replaced. An operator of the lamp system currently lacks any way of determining how many hours the lamp assembly has been historically operated. It is also common industry practice to replace the lamp assembly in one lamp system with another lamp assembly previously used in another lamp system or another lamp assembly retreived from storage. These exchanges compound the operator's difficulty in determining how many hours that any particular ultraviolet lamp assembly has been operated. If, during the drying or curing process, the lamp assembly fails or the ultraviolet output drops to an insufficient level, the process must be interrupted to replace the lamp assembly. Because the entire drying or curing process must be halted to install the new lamp assembly, such interruptions reduce production efficiency.

Lamp systems have also been developed that can receive and operate different types of lamp assemblies. For example, lamp systems may receive and operate lamp assemblies characterized by different spectral fills or with different electrical specifications. However, because of this flexibility, the operating parameters of the lamp head must be properly configured to match the particular lamp assembly. Because lamp assemblies are moved between different lamp systems with increasing frequency, this further compounds the problems of the operator in having a precise knowledge of the number of hours that a specific ultraviolet lamp assembly has been operated. In addition, the operator now has to be certain that the lamp head is properly configured to operate a newly connected lamp assembly.

In contemporary lamp systems, the configuration of the lamp head to operate properly with specific types of lamp assemblies and the tracking of the end of life for a lamp assembly are performed manually, which is prone to errors. For instance, if the operator neglects the recording of the manual tracking, operation of the lamp system may be interrupted because there is no way to anticipate that a particular lamp assembly is nearing its end of life.

What is needed, therefore, are lamp assemblies, lamp systems, and methods for operating lamps systems that overcome these and other deficiencies of conventional lamp assemblies and lamp systems, as well as deficiencies in conventional methods of operating such lamp systems.

### SUMMARY

Embodiments of the present invention provide lamp assemblies and lamp systems for use in, for example, curing or drying adhesives, sealants, inks, coatings, and other similar types of materials, as well as methods of operating lamp systems. Generally, the lamp system includes a lamp head with a controller, a lamp assembly with a lamp and a pair of end fixtures configured to connect the lamp assembly with the lamp head, and a data carrier mounted on the lamp assembly. The data carrier stores data associated with the lamp assembly. The lamp system further includes a data reader that is capable of reading the data stored on the data carrier.

In a preferred embodiment, the data stored on the data carrier includes an identifier associated with the lamp assembly. The identifier is a unique serial number or a part number associated with the lamp assembly. When the lamp assembly is installed into the lamp head, the data reader reads the identifier from the data carrier and communicates the identifier to the controller. The controller has a memory in which a number of hours of operation associated with the lamp assembly is stored. Based on the identifier read from the data carrier, the controller retrieves the number of hours of operation from its memory. The retrieved number of hours of operation is displayed to the lamp system operator. The controller tracks the operation of the lamp assembly and incrementally updates the number of hours of operation stored in the controller's memory. This automatic tracking eliminates the need for an operator to manually track the hours over which the lamp assembly is operating.

In an alternate embodiment, the controller stores operational data used to configure the lamp system in its memory. Based on the identifier read by the data reader from the data carrier, the controller retrieves the operational data from its memory and processes the retrieved operational data to configure the lamp system. In this manner, the lamp system may receive and operate lamp assemblies characterized by different electrical specifications. For example, the controller may configure the lamp system by changing cooling conditions for the lamp and/or by adjusting a voltage or current delivered from a power supply of the lamp system to the lamp assembly. Of course, both the identifier and operational data can be alternatively stored on the data carrier.

In an alternate embodiment, the data carrier contains data representing the type of lamp assembly, such as the specific spectral fill of the lamp. The controller stores operational data in its memory that is correlated with different types of lamp assemblies. The data reader reads the data representing the lamp assembly type from the data carrier and communicates this information to the controller. The controller then retrieves the operational data and configures the lamp system based on the data representing lamp assembly type.

In yet another alternate embodiment, the data carrier stores operational data used to configure the lamp system in its memory. Based on the operational data read from the data carrier by the data reader, the controller configures the lamp system for use with the lamp assembly. In this manner, the lamp system can receive and operate lamp assemblies characterized by different electrical specifications.

In yet additional embodiments, the data carrier may store any combination of the identifier, the data representing the type of lamp assembly, and the operational data. For example, the data carrier may store the identifier and the data representing the type of lamp assembly. The data reader retrieves these combinations of information from the data carrier and communicates the information to the controller. The controller stores the appropriate corresponding information to perform the required functions of the lamp system. Alternatively, the data carrier may store some portion of this information and the controller may store the remaining portion of this information. The controller may optionally display some or all of the data stored on the data carrier and/or in the controller memory to the operator of the lamp system.

In an alternate embodiment in which the lamp system further includes a data writer, the data on the data carrier represents a number of hours of operation associated with the lamp assembly. The data reader is used to read the data representing the hours of operation from the data carrier when the lamp assembly is installed in the lamp system. The controller then tracks the time over which the lamp assembly is operated by the lamp system and stores the cumulative operating time. The data writer is configured to write data representing the cumulative number of hours of operation back to the data carrier, which stores the data for future use. When the lamp assembly is used in different lamp systems, the data representing the number of hours of operation is carried by the data carrier along with the lamp assembly and is readily accessible to any arbitrary lamp system to which the lamp assembly is coupled. As a result, the lamp assembly is readily portable among different lamp systems with the operational life of the lamp assembly being accurately tracked by the information stored on the data carrier.

In yet additional embodiments in which the lamp system further includes a data writer, the data carrier may store any combination of the identifier, data representing the type of lamp assembly, the operational data, and the data representing the number of hours of operation. For example, the data carrier may store the identifier and the type of lamp assembly, in addition to the data representing the number of hours of operation. Under the command of the controller, the data reader is operative to read the information stored on the data carrier and the data writer is operative to write data representing the cumulative hours of operation to the data carrier. The controller stores the appropriate corresponding information to perform the required functions of the lamp system. Alternatively, the data carrier may store some portion of this information and the controller may store the remaining portion of this information. The controller may optionally display some or all of the information stored on the data carrier and/or in the controller memory to the operator of the lamp system.

In some embodiments of the lamp assembly, the data carrier is directly mounted to one or more of the end fixtures. In other embodiments, the data carrier is directly mounted to the lamp of the lamp assembly. Data carriers for the embodiments of the invention are selected from technologies such as magnetic systems, wireless systems, optical systems, or combinations of those systems. For example, the wireless systems may include technologies such as radio frequency identification (RFID), BLUETOOTH®, Wi-Fi, infrared, among others.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of an exemplary lamp head consistent with embodiments of the present invention.

FIG. 2 is a perspective view of a suitable lamp assembly, which may be mounted in the lamp head of FIG. 1.

FIG. 3 is a block diagram of a lamp system, which may be used with embodiments of the present invention.

FIG. 4 is a block diagram of a network topology, which may be used with embodiments of the present invention.

FIG. 5A is an operational flow chart for a lamp assembly in accordance with embodiments of the present invention.

FIG. 5B is a continuation of the flow chart in FIG. 5A.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments may have been enlarged or distorted relative to others to facilitate visualization and clear understanding. In particular, thin features may be thickened, for example, for clarity or illustration.

### DETAILED DESCRIPTION

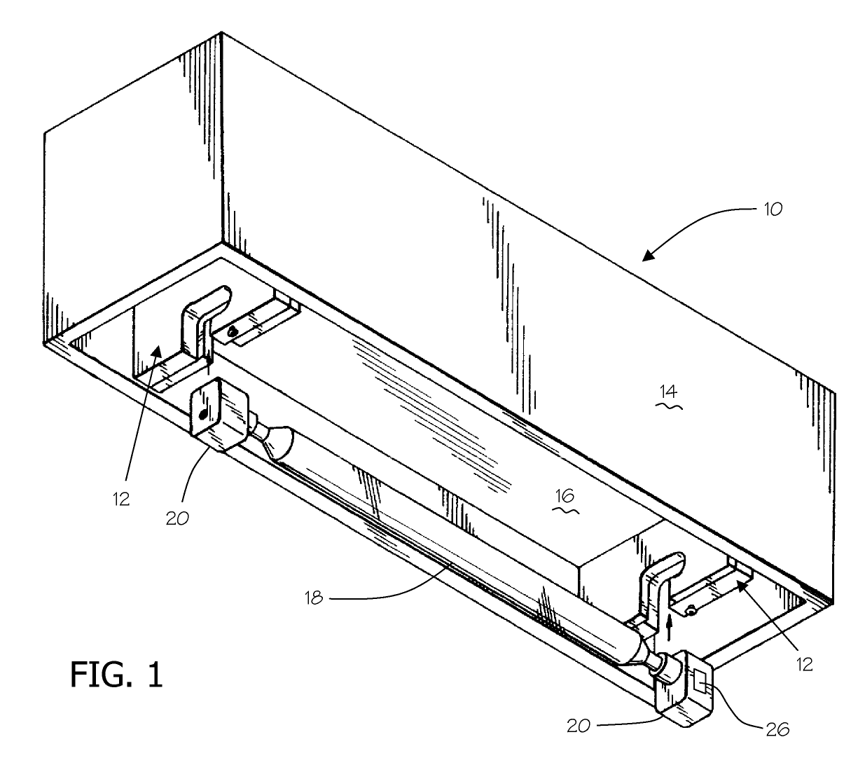

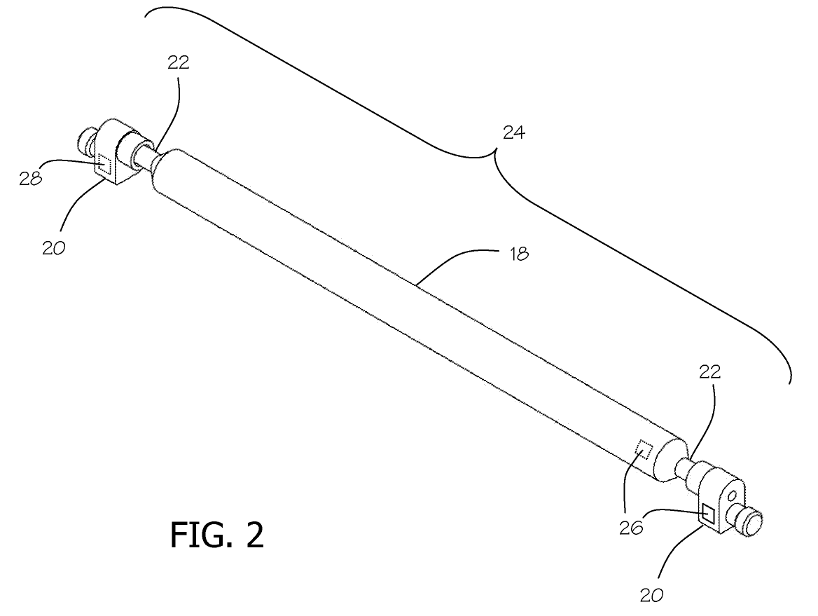

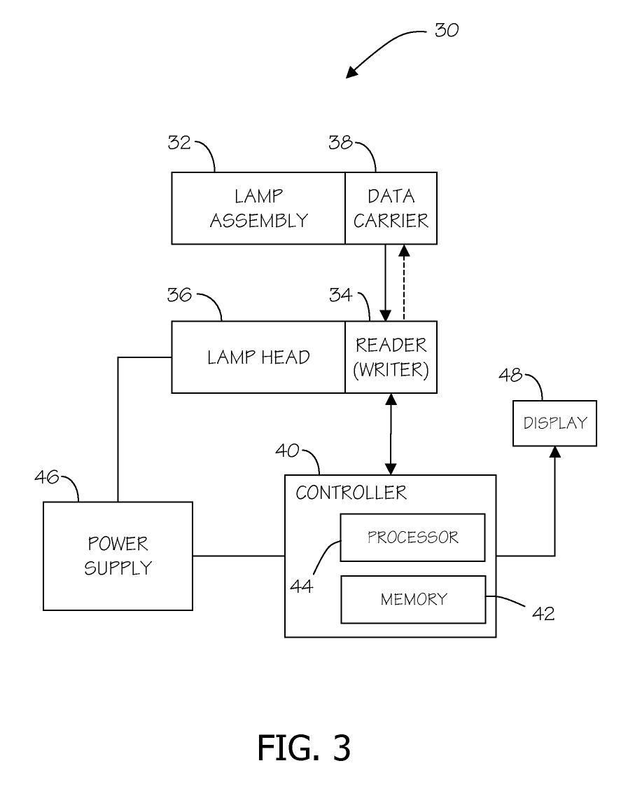

Turning to the drawings, wherein like numbers denote like parts throughout the several views, FIGS. 1 and 2 show an exemplary lamp head 10 that incorporates a lamp-retaining device 12. The lamp head 10 also includes a lamp housing 14 which may be operatively connected to a source of cooling water and a source of electricity (diagramatically shown in FIG. 3). In some configurations, the lamp housing 14 may include a water cooled section 16 which is operatively connected to the source of cooling water. The water cooled section 16 serves to cool the lamp head 10 while it is operational, such as during a curing application. The lamp system further includes a lamp assembly 24 which is selectively removable from the lamp retaining device 12 in the lamp head 10. The lamp head 10 may include a reflector (not shown), which includes a reflective surface partially surrounding the lamp 18 for reflecting radiation onto a substrate.

The lamp assembly 24 includes lamp 18 and end fixtures 20, which are secured to terminal ends 22 of lamp 18. Preferably, each end fixture 20 is made of a ceramic material. When the lamp 18 reaches the end of its useful life, the lamp assembly 24 may be removed and replaced with a new lamp assembly 24. In one embodiment, the lamp assembly 24 may be secured with the lamp head 10 using only a single end fixture 20.

A data carrier 26 is mounted on the lamp assembly 24, in order to be readable by a data reader (not shown) carried in the lamp head 10. The data reader may alternatively be positioned sufficiently close to the lamp head 10 so as to read the data carried on the data carrier 26 but not necessarily positioned in the lamp head 10. The data carrier 26 is preferably attached to one of the end fixtures 20, but may also be attached directly to the lamp 18. Other embodiments of the lamp assembly 24 may provide multiple data carriers 26, 28. These embodiments may utilize a single data reader to read the data from either of the data carriers when the lamp 18 is mounted in the lamp head 10. In some other embodiments, where the data carriers may include read/write functionality, the lamp head 10 may be provided with multiple read/write devices to read data from and write data to the data carriers.

The data carrier 26 may consist of any type of non-volatile memory device. In a specific embodiment, the data carrier 26 is a radio frequency identification (RFID) device also known as an RFID tag. An RFID tag is an object that can be applied to or incorporated into a product, such as the end fixtures 20 of the lamp 18, for the identification purposes using radiowaves. Some RFID tags can be read from several meters away and beyond the line of sight of the reader.

Many RFID tags contain at least two parts. One part is an integrated circuit for storing and processing information, modulating and demodulating a (RF) signal, and other specialized functions. Another part is an antenna for receiving and transmitting the signal. Generally, two types of RFID tags are used. The first type is a passive RFID tag, which has no internal power supply. A minute electrical current induced in the antenna by the incoming radio frequency signal generated by the reader provides just enough power for the integrated circuit in the tag to power up and transmit a response. Most passive tags signal by backscattering the carrier wave from the reader. This means that the antenna has to be designed both to collect power from the incoming signal and also to transmit the outbound backscatter signal. The response of a passive RFID tag is not necessarily just an ID number; the tag chip may also contain non-volatile, writable memory for storing data.

The second type of tag is an active RFID tag. Unlike passive RFID tags, active RFID tags have their own internal power source, which is used to power the integrated circuits and to broadcast the response signal to the reader. In embodiments of the present invention, power for an active RFID tag may be provided along with power for the lamp or may be provided by a battery source embedded in the RFID tag. Communications from active tags to readers is typically much more reliable (i.e., fewer errors) than from passive tags due to the ability for active tags to conduct a “session” with a reader. Active tags, because of their on board power supply, may also transmit at higher power levels than passive tags, allowing them to be more robust in RF challenged environments including reflective targets from metal or at longer distances.

One of ordinary skill in the art would realize that RFID devices are but one of several data storage devices that could be employed to store lamp related data. Additionally, other memory devices associated with the controller may be used, for example, with an RFID device supplying a unique identification to associate the stored data with specific lamps. Further alternatives may include magnetic systems, wireless systems, such as BLUETOOTH®, Wi-Fi, and Infrared, or optical systems, such as bar codes or a data matrix.

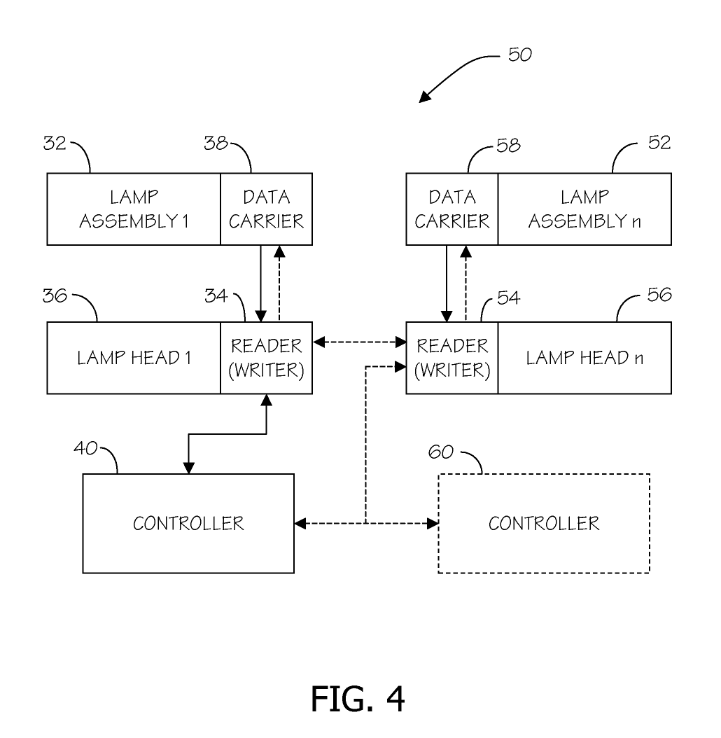

In a preferred embodiment of a lamp system 30, shown in the block diagram of FIG. 3, a lamp head 36 is switched on, but before a lamp assembly 32 is powered, a data reader 34 associated with lamp head 36 reads data from a data carrier 38, which uniquely identifies the lamp assembly (identifier). The identifier is used to retrieve lamp usage data, which primarily includes a number of hours of operation from a controller 40. The usage data is stored in a memory 42 of the controller. Memory 42 may represent random access memory (RAM) devices, as well as any supplemental levels of memory, e.g., cache memories, non-volatile or backup memories (e.g., programmable or flash memories), read-only memories, etc. In addition, memory 42 may be considered to include memory storage physically located elsewhere in controller 40 or lamp system 30, e.g., any cache memory in a processor 44, as well as any storage capacity used as a virtual memory, e.g., as stored on a mass storage device or another controller or computer coupled to controller 40 via a network (as seen in FIG. 4).

The number of hours of operation is retrieved from the memory 42 in the controller 40 and is displayed to the operator on the display 48. After power has been provided to the lamp assembly 32, the processor tracks the number of hours that the lamp assembly 32 is under power and then adds that time to the number of hours stored in the memory 42 to provide a cumulative number of hours of operation.

The data carrier 38 for the preferred embodiment is a read only device. Likewise the lamp system 30 need only be provided with the data reader 34 to be able to read the identifier stored on the data carrier.

In an alternative embodiment, the identifier is used to retrieve only operational data is stored in the memory 42 of the controller 40. The operational data includes information useful for the proper operation of the lamp, such as lamp voltage, lamp current, and lamp spectral fill type. The operational data read from the memory 42 of the controller 40 is then used by the controller 40 to configure the operating conditions specific to the lamp, thereby potentially optimizing lamp performance. The controller 40 first verifies that the lamp head 36 has the same characteristics as the lamp assembly 32. If so, the controller 40 configures the lamp system 30. The configuration involves changing the lamp cooling conditions and/or adjusting the voltage and current delivered from the power supply 46 to maintain electrical compatibility with the lamp assembly 32. After the lamp head 36 is properly configured the lamp assembly 32 is powered. Both the lamp head 36 and the controller 40 receive power from the lamp system power supply 46. In an alternative embodiment, the identifier is used to retrieve both data representing the number of hours of operation and operational data.

If, however, the controller 40 determines that the lamp head 36 and the lamp assembly 32 are not compatible, then the controller 40 notifies an operator of the lamp system 30 by displaying a message to the operator on a display 48 and configures the lamp system 30 to operate. After the notification and configuration, the lamp assembly 32 is then powered.

In an alternative embodiment of the lamp system 30 in FIG. 3, the data carrier 38 contains data representing the number of hours of operation, that was stored in the memory 42 of the processor. In this embodiment, the data carrier 38 will generally be a read-write device so that data, such as the number of hours of operation, can be periodically updated and written back to the data carrier 38 to reflect the current state of the lamp 32. In an alternative embodiment, the data carrier 38 may store data representing both the number of hours of operation, or the type of lamp, or operational data or the identifier, or any combination thereof.

Having data representing the number of hours of operation stored on the data carrier 38 assists in accurately tracking lamp life if the lamp assembly 32 is moved between different lamp heads 36. Operation of the lamp is monitored by the processor 44 in the controller 40 and the number of hours of operation is then updated by the processor 44. The updated number of hours of operation is written to the data carrier 38 to reflect the current state of the lamp assembly 32. The lamp assembly 32 may be discarded by an operator when it has reached its recommended rated life, or other adjustments may be made to the lamp system 30 to operate the lamp past its rated life.

After reading the data representing the number of hours of operation from the data carrier 38, the hours are displayed on the display 48 to an operator. If the hours of operation are within parameters, no adjustments are made to the lamp system 30 before the lamp assembly 32 is powered. If the hours of operation are nearing the rated life, an additional warning message is displayed to the operator and no adjustments are made to the lamp system before the lamp assembly 32 is powered. If, however, the number of hours has exceeded the rated hours for the lamp assembly 32, the operator will be notified and lamp assembly 32 may operate at a lower power level. Alternatively, the lamp assembly 32 may be operated at a higher power level since the output of the lamp assemblies 32 generally declines after exceeding the rated hours. Over-powering the assembly 32 in this situation may assist in providing a consistent output level from the lamp assembly 32.

In another alternative embodiment of the lamp system 30 in FIG. 3, the data carrier 38 contains only data representing the type of lamp. In this embodiment, the data reader 34 of the lamp system 30 reads the data representing the lamp type from the data carrier 38. Operational data corresponding to the lamp type is then retrieved from the memory 42. The controller 40 uses the operational data to check compatibility and to configure the lamp system 30, as disclosed with the preferred embodiment above.

In another alternative embodiment of the lamp system 30 in FIG. 3, the data carrier 38 contains only the operational data. In this embodiment, the data reader 34 of the lamp system 30 reads the operational from the data carrier 38. The controller 40 uses the operational data read from the data carrier 38 to check compatibility and configure the lamp system 30 as disclosed with the preferred embodiment above.

In another alternate embodiment of the lamp system 30 in FIG. 3, the data carrier 38 contains the identifier, operational data, and the data representing the number of hours of operation. In this embodiment, the data reader 34 has both read and write capabilities allowing the number of hours of operation to be read from and written to the data carrier 38. The data representing the number of hours of operation is read from the data carrier 38 and used by the controller 40 to notify the operator of the lamp, as disclosed in the embodiments above. The number of hours of operation is also used to notify the operator when the lamp is near the end of its life and adjust the power level of the lamp assembly 32 prior to the lamp assembly 32 being powered as disclosed above. After operation of the lamp system 30 for a given duration, the number of hours of operation is updated and written back to the data carrier 38 by the data writer 34. The data reader 34 also reads the operational data from the data carrier 38. The controller 40 uses the operational data read from the data carrier 38 to check compatibility and to configure the lamp system 30 as disclosed with the preferred embodiment above.

In some embodiments, if after the lamp assembly 32 is inserted into the lamp head 36, there is no operational data available, the data reader is unable to read operational data from the data carrier 38, or if the operational data indicates that the lamp assembly 32 is incompatible with the lamp head 36, then the controller 40 notifies the operator of the lamp system 30 by providing a message on the display 48 and the operator has the option of powering on the lamp assembly 32.

In various embodiments, information may be stored on the data carrier 38 and the memory of the controller 40 in any combination. For example, the data carrier 38 may store data representing the identifier and data representing the type of lamp assembly 32. The data reader 34 retrieves these combinations of information from the data carrier 38 and communicates the information to the controller 40. The controller 40 stores the appropriate corresponding information to perform the required functions of the lamp system 30. Alternatively, the data carrier 38 may store some portion of this information and the controller 40 may store the remaining portion of this information. The controller 40 may optionally display some or all of the data stored on the data carrier 38 and/or in the memory 42 to the operator of the lamp system 30.

The data reader (writer) for the embodiments discussed above is preferably contained in the lamp head, although the data reader (writer) may be located in any other related system within the lamp system. Whether or not the data reader is carried by the lamp head, the data reader may be automatically operatively engaged with the data carrier on mounting of the lamp assembly on the lamp head.

As disclosed with the embodiment above, the controller 40 is operable to automatically configure the operating conditions according to the operational data read from the data carrier 38. Therefore the need for manual reconfiguration is no longer necessary and reconfiguration may be carried out automatically according to the operational data, on mounting of the lamp assembly in the embodiments of the invention disclosed above.

As shown in FIG. 4, some embodiments of the lamp system 50 contain multiple lamp assemblies 32, 52 in multiple lamp heads 36, 56, which may each have its own controller 40, 60. The controllers 40, 60 communicate with each other using a network or other communication means as known in the art. In other embodiments, the data readers/writers 34, 54 may also communicate directly with one another. Further, the system 50 may be configured with a central controller 40 which communicates directly with the data readers (and/or writers) 34, 54 which read (write) data from the data carriers 38, 58 associated with each of the lamp assembly 32,52/lamp head 36, 56 configurations as discussed with the preferred embodiment above. The controller 40 in this configuration is operable to individually process operational data received from the reader 34, 54 for each lamp assembly 32, 52 and independently determine the suitability of the lamp assembly 32, 52 for each of the lamp assembly 32, 52/lamp head 36, 56 configurations with appropriate notifications to the operator. Additionally, usage data associated with each of the lamp assemblies 32, 52 read from the corresponding data carriers 38, 58 is used by the controller 40 to send the appropriate notifications to an operator regarding the life of each of the lamps 32, 52 and additional notifications if one of the lamps 32, 52 is near the end of its life and potential power adjustments to the lamp assembly 32, 52, as disclosed above. While FIG. 4 illustrates two lamp assemblies 32, 52 with data carriers 38, 58 and two lamp heads 36, 56 with readers (writers) 34, 54, one skilled in the art will realize that any number of lamp assemblies and lamp heads may be used either with its own controller or with a common controller 40.

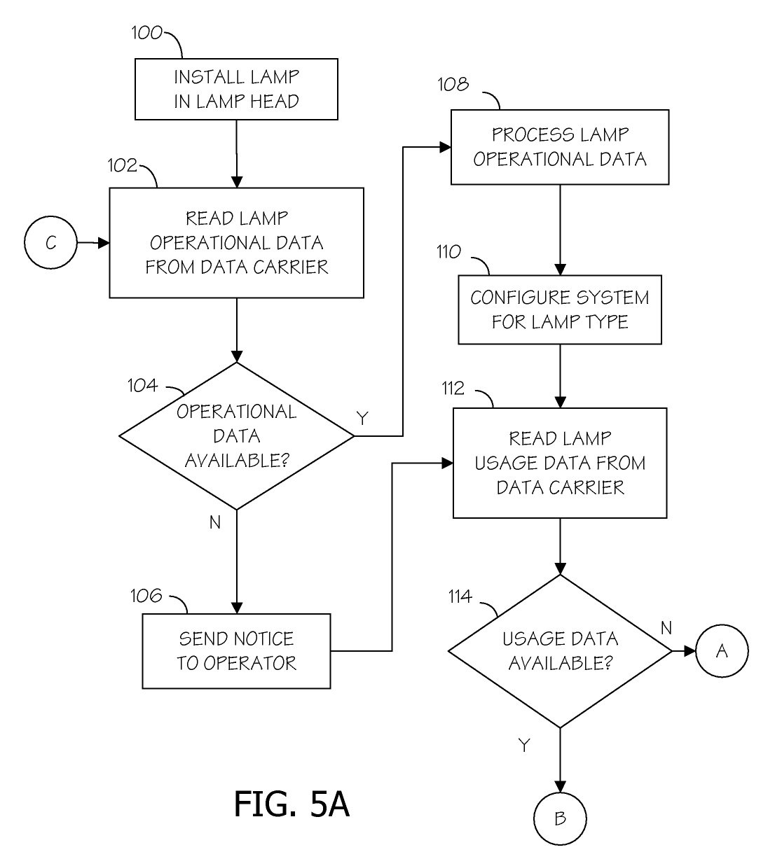

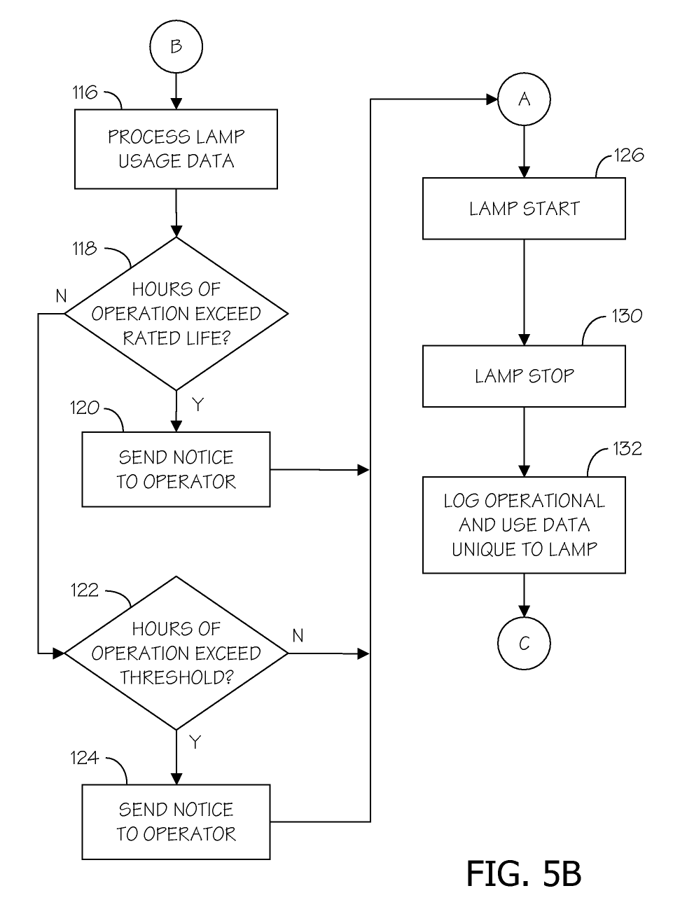

FIG. 5A and FIG. 5B show a flow chart depicting an operation of a specific embodiment of a lamp system such as those disclosed in conjunction with FIGS. 1-4 above. However, the methods of operation for some of the embodiments are not shown in the flow chart, but are apparent from the preceding description. The method of operation depends on the data stored on the data carrier itself and the data stored in the memory of controller. The following illustrates a situation in which usage data and operational data are stored on data carrier.

The method begins when a lamp assembly with a data carrier is installed in a lamp head (block 100). In embodiments where only an identifier is stored on the data carrier, usage data and operational data are retrieved from the controller memory. A data reader associated with the lamp head reads operational data from the data carrier (block 102). If the operational data is not available on the data carrier (“No” branch of decision block 104), then a notice is sent to an operator of the lamp system (block 106) and the operator may potentially manually configure the lamp system. Then, process then continues at block 112. If the operational data is available on the data carrier (“Yes” branch of decision block 104), the data is processed by a controller (block 108) to configure the lamp system for the lamp type (block 110) based on the operational data read from the data carrier.

The data carrier is then further interrogated to read usage data from the data carrier (block 112). If usage data is available (“Yes” branch of decision block 114), then the usage data is processed by the controller (block 116). As disclosed with the embodiments presented above, the usage data includes hours of lamp usage that can be used to predict the end of the life of the lamp. The controller checks to determine if the hours of the lamp have exceeded the lamp's rated hours. If the rated hours have been exceeded (“Yes” branch of decision block 118), then the controller will display a notice to the operator (block 120) and the process continues at block 126.

If the rated hours have not been exceeded (“No” branch of decision block 118), then an additional check is made by the controller to determine if the lamp is nearing the end of life by checking to see if the hours of operation have exceeded a predetermined threshold. If the threshold has been exceeded (“Yes” branch of decision block 122), then a notice may be sent to an operator (block 124) of the lamp identifying the hours accumulated and potentially an estimate of the remaining hours of the lamp. After notification (blocks 120, 124), or if usage data is not available (“No” branch of decision block 114), the lamp is started (block 126). In other embodiments, the data may be logged in the controller and associated with the lamp identification data read from the data carrier. At the conclusion of the irradiation operation, the lamp is stopped (block 130), and again the operation of the lamp may be logged (block 132) either on the data carrier or in the controller. The process may then be repeated with the same lamp at block 102 or with a different lamp at block 100.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A lamp assembly for use in a lamp system having a lamp head and a data reader, the lamp assembly comprising:
a lamp;
at least one end fixture configured to connect said lamp with the lamp head; and
a data carrier mounted to said at least one end fixture or said lamp, said data carrier configured to store data associated with said lamp that is readable by the data reader.

2. The lamp assembly of claim 1 wherein said data carrier is mounted to said at least one end fixture.

3. The lamp assembly of claim 1 wherein said data carrier is selected from the group consisting of a magnetic system, a wireless system, an optical system, and combinations thereof.

4. The lamp assembly of claim 1 wherein said data represents an identifier, or a lamp type, or operational data associated with said lamp assembly, or combinations thereof.

5. A lamp assembly for use in a lamp system having a lamp head, a data reader, and a data writer, said lamp assembly comprising:
a lamp;
at least one end fixture configured to connect said lamp with the lamp head; and
a data carrier mounted to said at least one end fixture or said lamp, said data carrier configured to store data representing a number of hours of operation associated with said lamp, and said data carrier configured to store data representing an incremented number of hours of operation written from the data writer.

6. The lamp assembly of claim 5 wherein said data carrier is selected from the group consisting of a magnetic system, a wireless system, an optical system, and combinations thereof.

7. The lamp assembly of claim 5 wherein said data carrier is further configured to store data representing an identifier, or a lamp type, or operational data associated with said lamp assembly, or combinations thereof.

8. A lamp system comprising:
a lamp head;
a lamp assembly connected to said lamp head, said lamp assembly having a lamp and a data carrier configured to store data associated with said lamp;
a data reader configured to read said data from said data carrier; and
a controller coupled with said lamp head and said data reader, said controller operable to receive said data from said data reader and operable to process said data.

9. The lamp system of claim 8 wherein said data represents an identifier, and said controller comprises:
a processor;
a memory coupled with said processor; and
a display coupled with said processor,
wherein said memory is configured to store data representing a number of hours of operation of said lamp assembly associated with said identifier, said processor is operable to process said data representing the number of hours of operation retrieved by said processor from said memory, and said number of hours of operation are displayed on said display to an operator of the lamp system.

10. The lamp system of claim 9 wherein said memory is further configured to store operational data associated with said identifier, and said processor is operable to configure said lamp head based upon said operational data.

11. The lamp system of claim 9 wherein said processor is configured to increment said number of hours of operation when said lamp assembly is under power and store data representing said incremented number of hours in said memory.

12. The lamp system of claim 8 wherein said data represents an identifier, and said controller comprises:
a processor; and
a memory coupled with said processor,
wherein said memory is configured to store data representing operational data of said lamp assembly associated with said identifier, and said processor is operable to configure said lamp head based on said operational data.

13. The lamp system of claim 8 wherein said lamp assembly comprises:
at least one end fixture configured to connect said lamp with said lamp head, said data carrier mounted to said at least one end fixture or said lamp.

14. The lamp system of claim 8 wherein said data represents a lamp type associated with said lamp assembly, and said controller has a processor and a memory coupled with said processor,
wherein said memory is configured to store operational data associated with said lamp type, and said processor is operable to configure said lamp head based upon said operational data.

15. The lamp system of claim 8 wherein said data represents operational data associated with said lamp assembly, and said controller operable to process said operational data and to configure the lamp system based on said operational data.

16. A lamp system comprising:
a lamp head;
a lamp assembly connected to said lamp head, said lamp assembly having a lamp and a data carrier, and said data carrier configured to store data representing a number of hours of operation associated with said lamp;
a data reader configured to read said data representing said number of hours of operation from said data carrier;
a controller coupled with said lamp head and said data reader, said controller is operable to increment said number of hours of operation when said lamp assembly is under power and to configure said lamp head of said lamp system;
a display coupled with said controller, said display configured to display said number of hours of operation; and
a data writer coupled with said controller, said data writer configured to write said incremented number of hours of operation to said data carrier.

17. The lamp system of claim 16 wherein said lamp assembly comprises:
at least one end fixture configured to connect said lamp with said lamp head, said data carrier mounted to said at least one end fixture or said lamp.

18. The lamp system of claim 16 wherein said data carrier is further configured to store an identifier associated with said lamp assembly, and said data reader is further configured to read said identifier from said data carrier.

19. The lamp system of claim 18 wherein said controller comprises:
a processor; and
a memory coupled with said processor,
wherein said memory is configured to store operational data associated with said identifier and used to configure the lamp system, and said processor is operable to process said operational data stored in said memory.

20. The lamp system of claim 16 wherein said data carrier is further configured to store operational data of said lamp assembly, said data reader is further configured to read said operational data from said data carrier, and said controller further configures the lamp system based on said operational data.

21. The lamp system of claim 16 wherein said controller is further operable to adjust an input power to said lamp assembly if said number of hours of operation exceed a rated number of hours.

22. A method of operating a lamp system, the lamp system having a lamp head, a lamp assembly having a lamp, a data carrier mounted on the lamp assembly, a data reader, and a controller, the method comprising:
mounting the lamp assembly in the lamp head;
reading data associated with the lamp from the data carrier with the data reader;
processing the data read from the data carrier with the controller; and
operating the lamp system to power the lamp assembly and thereby cause emission of ultraviolet radiation from the lamp assembly.

23. The method of claim 22 wherein the data represents an identifier, and further comprising:
retrieving operational data associated with the identifier from a memory of the controller;
processing the operational data with the controller; and
configuring the lamp system for use with the lamp assembly based on the operational data.

24. The method of claim 23 further comprising:
in response to the operational data being incompatible with the lamp head, notifying an operator.

25. The method of claim 22 wherein the data further represents a lamp type, and further comprising:
retrieving operational data associated with the lamp type from a memory of the controller;
processing the operational data with the controller; and
configuring the lamp system for use with the lamp assembly based on the operational data.

26. The method of claim 22 wherein the data represents an identifier, and further comprising:
retrieving a number of hours stored in a memory of the controller associated with the identifier; and
displaying the number of hours of operation to an operator of the lamp system.

27. The method of claim 26 further comprising:
retrieving operational data associated with the identifier from the memory of the controller;
processing the operational data with the controller; and
configuring the lamp system for use with the lamp assembly based on the operational data.

28. A method of operating a lamp system, the lamp system having a lamp head, a lamp assembly, a data carrier mounted on the lamp assembly, a data reader, a data writer, and a controller, the method comprising:
mounting the lamp assembly in the lamp head;
reading data representing a number of hours of operation from the data carrier with the data reader;
displaying the number of hours of operation to an operator of the lamp system;
operating the lamp system to power the lamp assembly and thereby cause emission of ultraviolet radiation from the lamp assembly;
incrementing the number of hours of operation when the lamp assembly is under power; and
writing the incremented number of hours of operation to the data carrier with the data writer.

29. The method of claim 28 further comprising:
reading an identifier from the data carrier with the data reader;
retrieving operational data associated with the identifier and stored in a memory associated with the controller;
processing the operational data with the controller; and
automatically configuring the lamp system for use with the lamp assembly based on the operational data.

30. The method of claim 28 further comprising:
reading operational data from the data carrier;
processing the operational data with the controller; and
automatically configuring the lamp system for use with the lamp assembly based on the operational data.
